(19) United States
(12) Patent Application Publication
(10) Pub. No.: US 2012/0079927 A1
(43) Pub. Date: Apr. 5, 2012

(54) MOLD OF REMOVING CHIPS

(75) Inventors: Xiao-ping Wu, Tu Cheng (TW); Shih-hsiung Ho, Tu Cheng (TW); Kun-hsueh Chiang, Tu Cheng (TW)

(73) Assignee: Cheng Uei Precision Industry Co., LTD., Tu Cheng City (TW)

(21) Appl. No.: 12/896,841

(22) Filed: Oct. 1, 2010

(51) Int. Cl. B26D 7/06

(52) U.S. Cl. 83/78

(57) ABSTRACT

Provided is a mold of removing chips for machining a product with center pins. The mold includes a plurality of first forming grooves disposed on an upper end thereof, a plurality of second forming grooves disposed on a lower end thereof, and at least two chip-removing grooves separately disposed on the upper and lower ends thereof. The first and second forming grooves separately divide the upper and lower ends into a plurality of upper and lower cores. The chip-removing grooves are separately cutting the first and second forming grooves. The chip-removing grooves can make the chips be easily removed out of the mold for preventing the chips from blocking up the first and second forming grooves and avoiding the deformation of the upper and lower cores, thereby enhancing the strength of the mold, elongating the useful life thereof and ensuring the machining precision of the product.

### BACKGROUND OF THE INVENTION

1. Field of the Invention

The present invention relates to a mold for machining a product with center pins, and more particularly to a mold of removing chips, which is used to machine a product with center pins.

2. Description of the Prior Art

At present, a product with center pins has been widely used in the market. The center pins of the product has higher, smaller and thinner features, so that the mold for machining the center pins needs to have forming grooves corresponding to the center pins. The prior mold for machining the center pins is described as follows.

Please refer to FIG. 1, the prior mold 2 for machining the center pins disposes a plurality of first forming grooves 21, which are parallel each other and are used to machine the profiles of the center pins, on an upper end thereof. The first forming grooves 21 are passing through a front surface and a back surface of the mold 2, and the upper end of the mold 2 is divided into several upper cores 22 by the first forming grooves 21. The mold 2 disposes a plurality of second forming grooves 23, which are corresponding to the first forming grooves 21 and are also used to machine the profiles of the center pins, on a lower end thereof. The lower end of the mold 2 is divided into several lower cores 24 by the second forming grooves 21. When using the mold 2, the product is first fixed, and then the mold 2 straightly faces to the product, and next the mold 2 can be driven to move back and forth toward the product till the center pins is formed on the product.

However, each of the upper cores 22 is continuous on the upper end of the mold 2 because each of the first forming grooves 21 is continuous, and each of the lower cores 24 is continuous on the lower end of the mold 2 because of each of the second forming grooves 23 being continuous. When the mold 2 machining the product, the continuous first forming grooves 21 and the continuous second forming grooves 23 are difficult to remove chips produced in the machining process out of the mold 2, so that the chips difficultly removed from the mold 2 can be stored in the first and second forming grooves 21, 23. When the chip storage arrives at some degree, the first and second forming grooves 21, 23 will be blocked up by the chips. If the first and second forming grooves 21, 23, which are now blocked up, go on machining the product, the stress concentration can result in deformations of the continuous first and second forming grooves 21, 23, and the strengths of the upper and lower cores 22, 24 are also reduced. Therefore, on one hand, the normal useful life of the prior mold 2 is reduced and the production cost is increased, and on the other hand, the product machined by the prior mold 2 cannot fulfill the required precision demand.

### BRIEF SUMMARY OF THE INVENTION

An object of the present invention is to provide a mold of removing chips, which can assure the machining precision of the product, elongate the normal useful life, and reduce the production cost.

To achieve the above object, in accordance with the present invention, a mold of removing chips is provided for machining a product with center pins, comprising: a plurality of first forming grooves, a plurality of second forming grooves and at least two chip-removing grooves. The first forming grooves are disposed on an upper end thereof, parallel each other and used to machine the profiles of the center pin. The first forming grooves pass through a front surface and a back surface of the mold, and divide the upper end of the mold into a plurality of upper cores. The second forming grooves are disposed on a lower end thereof and are corresponding to the first forming grooves. The second forming grooves divide the lower end of the mold into pluralities of lower cores. The chip-removing grooves are separately disposed on the upper end and the lower end of the mold, and are separately cutting the first and second forming grooves.

Based on the above description, a mold of removing chips as provided by the present invention disposes the chip-removing grooves on the upper and lower ends thereof to divide the continuous first and second forming grooves into several segments. When the mold is machining the product, the chips stacked in all segments of the first and second forming grooves can be easily removed out of the mold through the chip-removing grooves, thereby effectively overcoming the stress concentration of the continuous upper and lower cores caused by the chips blocking up the continuous first and second forming grooves of the prior mold, further overcoming the deformation of the upper and lower cores of the prior mold and resolving the problem of the strength of the upper and lower core of the prior mold. Therefore, the mold of the present invention can enhance the strength of the upper and lower cores to fulfill the precision demand of the product with the center pins. Moreover, the mold of the present invention can elongate the normal useful life of the upper and lower cores for reducing the production cost of the product with the center pins.

### BRIEF DESCRIPTION OF THE DRAWINGS

FIG. 1 is a structure schematic view of a prior mold for machining a product with center pins;

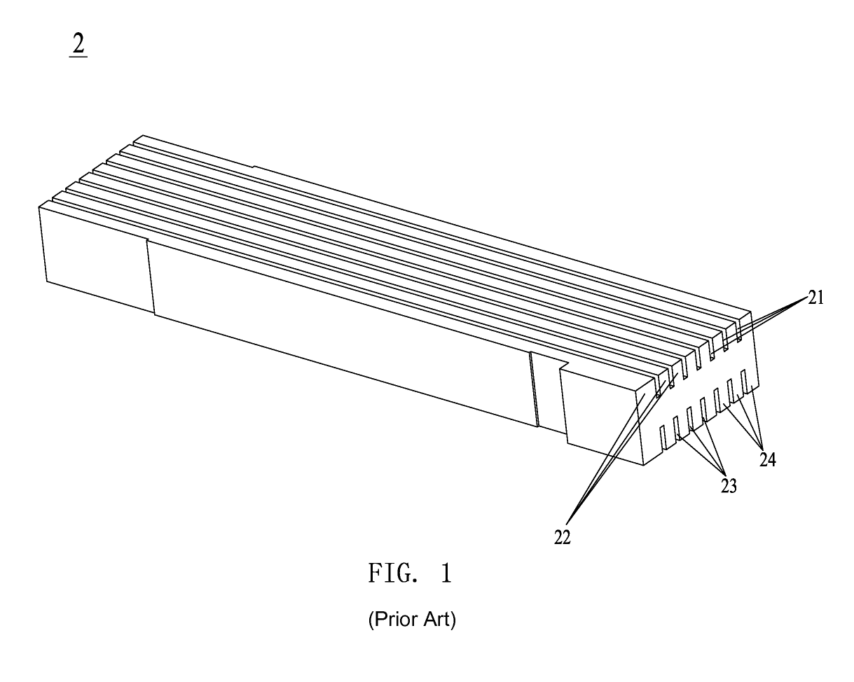

FIG. 2 is a structure schematic view of a mold of removing chips according to a first embodiment of the present invention;

FIG. 3 is a structure schematic view of the mold of removing chips according to a second embodiment of the present invention;

FIG. 4 is a structure schematic view of the mold of removing chips according to a third embodiment of the present invention;

FIG. 5 is a structure schematic view of another angle of the mold of removing chips of FIG. 4;

FIG. 6 is a schematic state view showing that the mold of FIG. 4 is machining the product with center pins; and

FIG. 7 is a schematic state view after the mold of FIG. 4 machines the product with center pins along a first direction shown by an arrow A in FIG. 6.

### DETAILED DESCRIPTION OF THE PREFERRED EMBODIMENTS

The following embodiment with reference to the accompanying drawings now has been given for detail describing the technology, the feature, the object and the effect of the present invention.

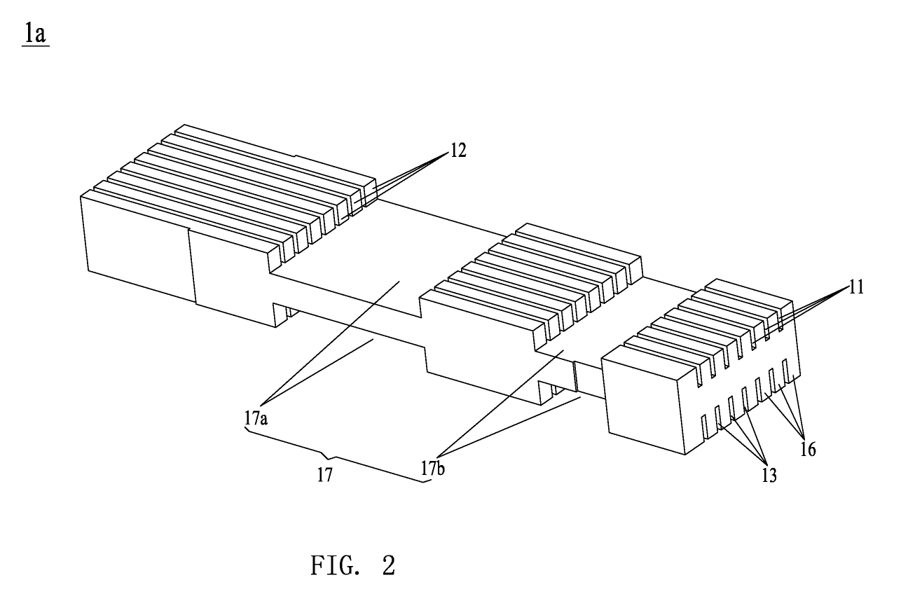

Please refer to FIG. 2, which shows a first embodiment of a mold 1a of removing chips according to the present invention. In FIG. 2, the mold 1a of removing chips is used to machine a product having higher, smaller and thinner center pins. The mold 1a disposes a plurality of first forming grooves 11, which are parallel each other and are used to machine the profiles of the center pins, on an upper end thereof. The first forming grooves 11 are preferably arranged with equal space on the upper end of the mold 1a for satisfying the process needs. The first forming grooves 11 pass through a front surface and a back surface of the mold 1a. The upper end of the mold 1a is divided into a plurality of upper cores 12 by the first forming grooves 11. The number of the first forming grooves 11 is determined by the number of the center pins waiting to be formed, and the number of the upper cores 12 is determined by the number of the first forming grooves 11.

The mold 1a disposes a plurality of second forming grooves 13, which are corresponding to the first forming grooves 11 and are also used to machine the profiles of the center pins, on a lower end thereof. Preferably, each one of the second forming grooves 13 is straightly facing to one of the first forming grooves 11, thereby being convenient for machining the product. Moreover, the lower end of the mold 1a is divided into a plurality of lower cores 16 by the second forming grooves 21. The number of the lower cores 16 is determined by the center pins waiting to be formed, so the number is not limited here. In order to remove the chips stacked in the first and second forming grooves 11, 13 out of the mold 1a, prevent the chips from blocking up the first and second forming grooves 11, 13, and avoid the deformation of the upper and lower cores 12, 16 generated by the stress concentration of the upper and lower cores 12, 16 and caused by blocking up the first and second forming grooves 11, 13, the mold 1a of the present invention disposes chip-removing grooves 17 on the upper and lower ends thereof. The chip-removing grooves 17 cut the first and second forming grooves 11, 13. For further reducing the stress suffered by the upper and lower cores 12, 16, the chip-removing grooves 17 are symmetrically formed on the upper end and the lower end of the mold 1a, and are arranged along the direction of perpendicular to the first forming grooves 11. The detail description of the chip-removing grooves 17 is as follows:

Preferably, each one of the chip-removing grooves 17 comprises a first chip-removing groove 17a and a second chip-removing groove 17b. The first chip-removing groove 17a is adjacent to a front end of the mold 1a, and the second chip-removing groove 17b is adjacent to a back end of the mold 1a. Both the upper and lower cores 12, 16 are divided into three segments by the chip-removing grooves 17, so that being more convenient for removing the chips in the first and second forming grooves 11, 13 out of the mold 1a to prevent the chips from blocking up the first and second forming grooves 11, 13, and avoid the deformation of the upper and lower cores 12, 16 generated by the stress concentration of the upper and lower cores 12, 16 and caused by blocking up the first and second forming grooves 11, 13. Therefore, the mold 1a of the present invention can enhance the machining precision of the product. Moreover, the chip-removing grooves 17 are not limited to include the first and second chip-removing grooves 17a, 17b, and also may include the more other grooves, which are disposed according to the factual length of the mold 1a of the present invention. It needs to be noted that the front, back, upper and lower ends of the mold 1a are based on FIG. 2.

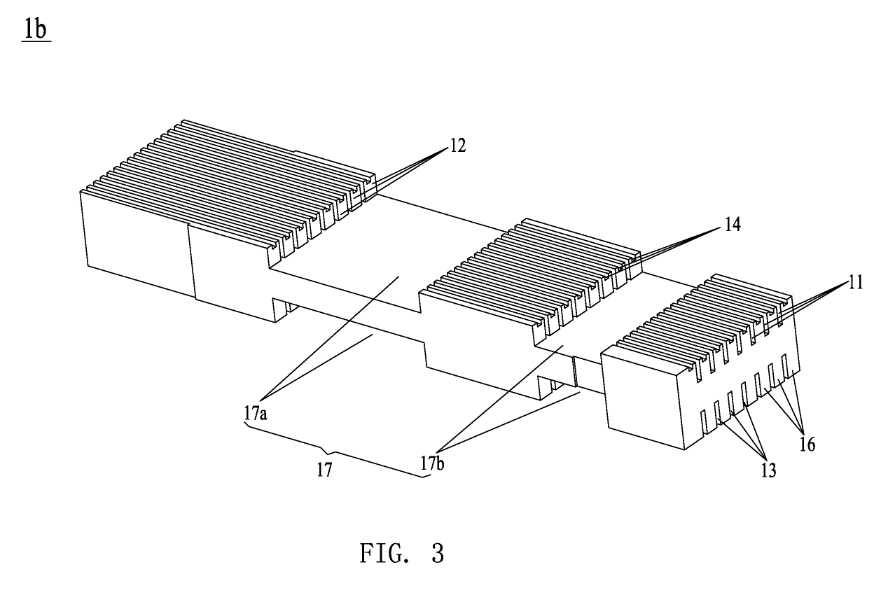

Referring to FIG. 3, which is showing a second embodiment of the mold 1b of the present invention. In FIG. 3, the structure of the mold 1b of the second embodiment is similar to that of the mold 1a of the first embodiment. The difference between them is that the upper core 12 of the mold 1b of the second embodiment disposes a third forming groove 14, which is parallel to the first forming groove 11 and is used to machine the profiles of the center pins. Each one of the upper cores 12 is corresponding to one third forming groove 14, and the chip-removing grooves 17 cut the third forming grooves 14, thereby enhancing the machining efficiency of the mold 1b.

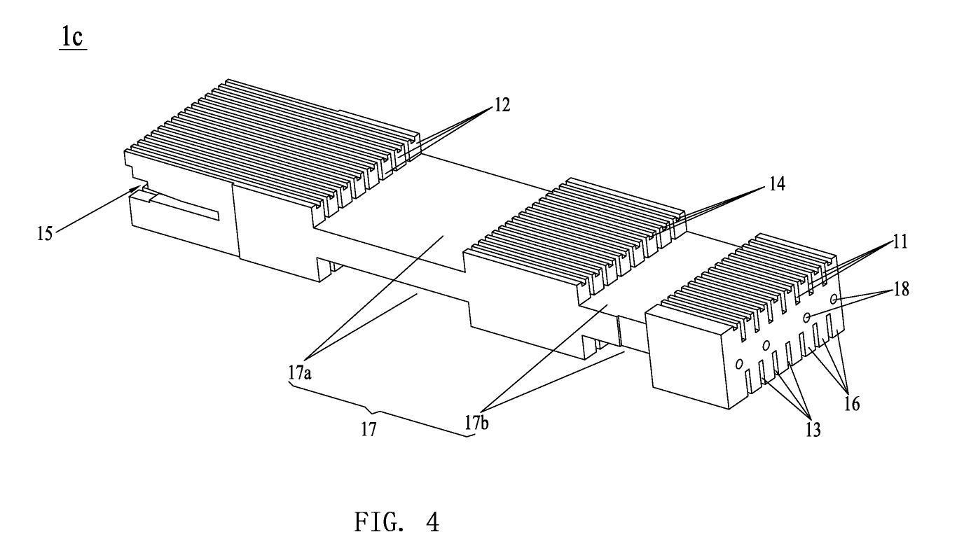

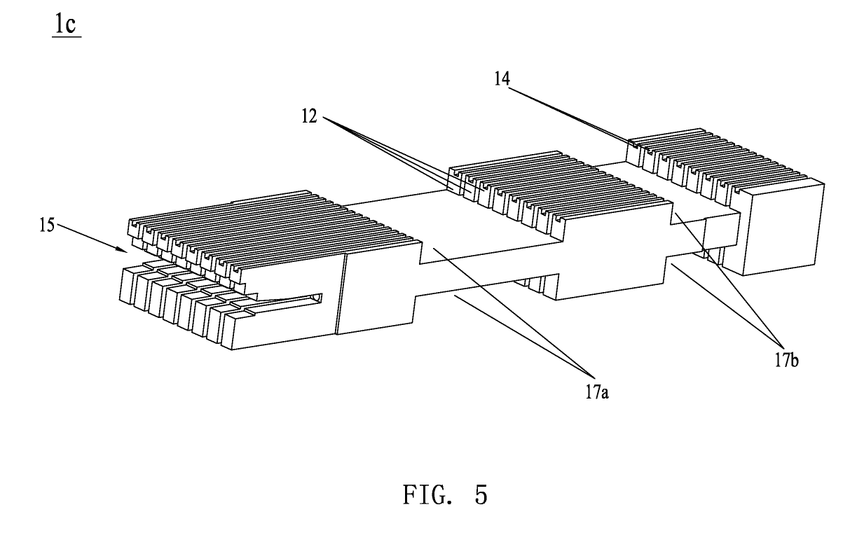

Please refer to FIGS. 4 and 5, which are showing a third embodiment of the mold 1c of the present invention. In FIGS. 4 and 5, the structure of the mold 1c of the third embodiment is similar to that of the mold 1b of the second embodiment. The difference between them is that the front end of the mold 1c of the third embodiment disposes a fourth forming groove 15 communicated with the first and second forming grooves 11, 13 and used to machine the profiles of the center pins, and the back end of the mold 1c also disposes at least one chip-removing hole 18 communicated with the fourth forming groove 15, thereby more further enhancing the machining efficiency of the mold 1c.

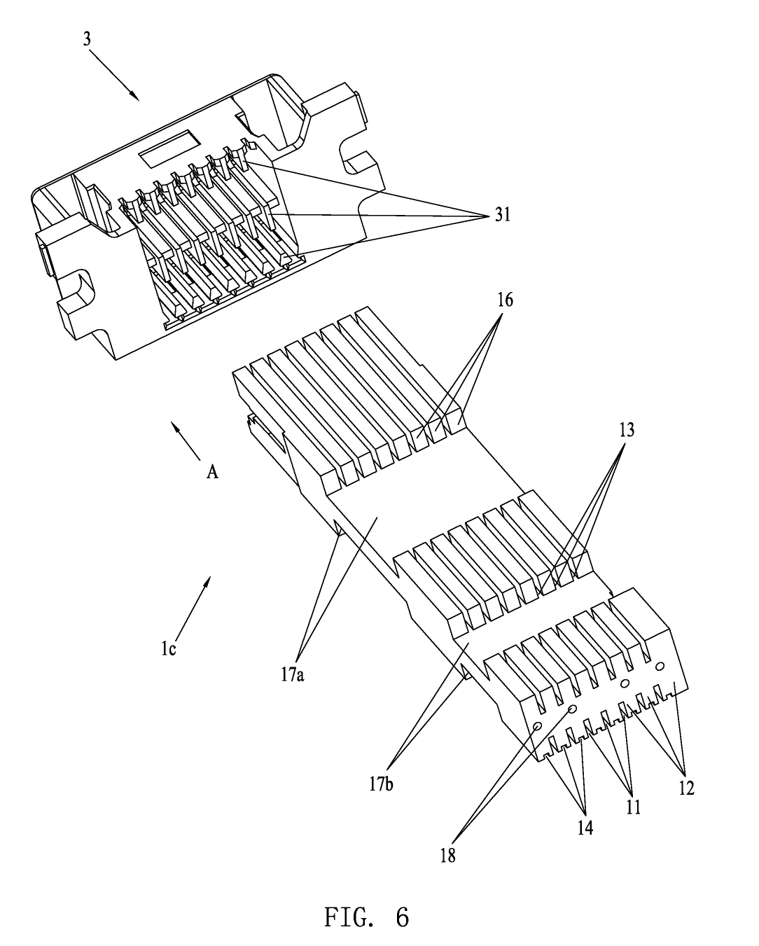

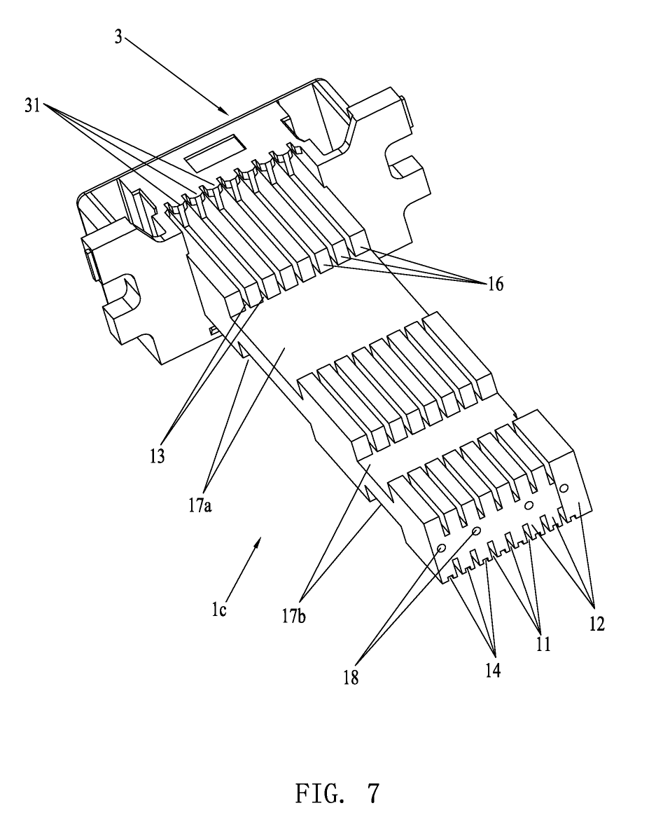

Please refer to FIGS. 6 and 7, which show a machining state of the mold 1c of machining the product 3 with center pins 31 on the third embodiment. When machining the product 3, the product is first fixed, then the mold 1c is adjusted for exactly facing to the product 3, and then the mold 1c can be driven to move along a first direction pointed by an arrow A for machining the product 3 till the center pins 31 is formed on the product 3. During machining the center pins 31 of the product 3, the chips falling into the first, second and third forming grooves 11, 13, 14 can be easily removed out of the mold 1c through the chip-removing grooves 17. Therefore, the mold 1c can improve the machining efficiency of the center pins 31 of the product 3.

As described above, the mold 1a of the present invention disposes the chip-removing grooves 17 on the upper and lower ends thereof to divide the continuous first and second forming grooves 11, 13 into several segments. When the mold 1c is machining the product, the chips stacked in all segments of the first and second forming grooves 11, 13 can be easily removed out of the mold 1c through the chip-removing grooves 17, thereby effectively overcoming the stress concentration of the continuous upper and lower cores caused by the chips blocking up the continuous first and second forming grooves of the prior mold, further overcoming the deformation of the upper and lower cores of the prior mold and resolving the problem of the strength of the upper and lower core of the prior mold. Therefore, the mold 1a of the present invention can enhance the strength of the upper and lower cores 12, 16 to fulfill the precision demand of the product with the center pins. Moreover, the mold 1a of the present invention can elongate the normal useful life of the upper and lower cores 12, 16 for reducing the production cost of the product with the center pins. And the molds 1b, 1c of the present invention have some advantages with the mold 1a.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A mold of removing chips, which is adapted to machine a product with center pins, comprising:
a plurality of first forming grooves, being disposed on an upper end thereof, parallel each other and used to machine the profiles of the center pin, wherein the first forming grooves pass through a front surface and a back surface of the mold and divide the upper end of the mold into a plurality of upper cores;
a plurality of second forming grooves, being disposed on a lower end thereof and corresponding to the first forming grooves, wherein the second forming grooves divide the lower end of the mold into pluralities of lower cores; and
at least two chip-removing grooves, being separately disposed on the upper end and the lower end thereof, and separately cutting the first and second forming grooves.

2. The mold of removing chips as claimed in claim 1, wherein the first forming grooves are arranged with equal space on the upper end, and each one of the first forming grooves is straightly facing to one of the second forming grooves.

3. The mold of removing chips as claimed in claim 1, further comprising a third forming groove, being disposed on each one of the upper cores and capable of machining the profiles of the center pins, wherein the chip-removing groove on the upper end cuts the third forming grooves on all the upper cores.

4. The mold of removing chips as claimed in claim 1, further comprising a fourth forming groove disposed on a front end thereof and at least one chip-removing hole disposed on a back end thereof, wherein the fourth forming groove is communicated with the first and second forming grooves and is capable of machining the profiles of the center pins, and the chip-removing hole is communicated with the fourth forming groove.

5. The mold of removing chips as claimed in claim 1, wherein said chip-removing grooves are symmetrically arranged on the upper and lower ends of the mold.

6. The mold of removing chips as claimed in claim 5, wherein said chip-removing grooves are arranged along the direction of perpendicular to the first forming grooves.

7. The mold of removing chips as claimed in claim 6, wherein each one of said chip-removing grooves comprises a first chip-removing groove being adjacent to a front end of the mold and a second chip-removing groove being adjacent to a back end of the mold.
